(19) United States
(12) Patent Application Publication
(10) Pub. No.: US 2019/0073541 A1
(43) Pub. Date: Mar. 7, 2019

(54) LANE DETECTION SYSTEM FOR VEHICLE

(71) Applicant: Magna Electronics Inc., Auburn Hills, MI (US)

(72) Inventor: Krishna Koravadi, Rochester Hills, MI (US)

(21) Appl. No.: 16/123,292

(22) Filed: Sep. 6, 2018

Related U.S. Application Data
(60) Provisional application No. 62/555,224, filed on Sep. 7, 2017.

(51) Int. Cl. G06K 9/00; B60W 30/12; G05D 1/00; G08G 1/16

(52) U.S. Cl. CPC G06K 9/00798; B60W 30/12; G05D 2201/0213; G08G 1/167; B60W 2420/42; G05D 1/0088

(57) ABSTRACT

A lane determining system for a vehicle includes a camera disposed at the vehicle so as to have a field of view forward of the vehicle. The camera captures image data. A non-vision based sensor is disposed at the vehicle so as to have a field of sensing forward of the vehicle. The non-vision based sensor captures sensor data. A control includes at least one processor operable to process image data captured by the camera and sensor data captured by the non-vision based sensor. The control, responsive to processing of captured image data, detects visible lane markers painted on the road along which the vehicle is traveling. The control, responsive to processing of captured sensor data, detects road-embedded elements disposed along the road. The control determines at least the lane along which the vehicle is traveling based on the detected lane markers or the detected road-embedded elements.

### CROSS REFERENCE TO RELATED APPLICATION

The present application claims the filing benefits of U.S. provisional application Ser. No. 62/555,224, filed Sep. 7, 2017, which is hereby incorporated herein by reference in its entirety.

### FIELD OF THE INVENTION

The present invention relates generally to a vehicle sensing system for a vehicle and, more particularly, to a vehicle sensing system that detects lane markers along a road being traveled by the vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a driver assistance system or lane detecting system for a vehicle that utilizes one or more sensors for sensing elements or objects embedded in a road along lane markers of the road on which the vehicle is traveling. The system may also include one or more cameras that capture image data representative of images exterior of the vehicle, and may detect lane markers on the road.

The present invention comprises a method and apparatus to detect the lane location reliably even in the bad weather conditions and even when the lane marking on the surface of the road is missing due to wear and tear of the road surface. The system of the present invention may be deployed in the existing infrastructure with minimum changes where objects or elements that could be detected by radar technology or similar are inserted below the road surface along the existing lane marking with a gap in between. The system can detect these objects or elements embedded below the road surface even in bad weather conditions and even where there are worn or no lane markings conditions.

These and other objects, advantages, purposes and features of the present invention will become apparent upon review of the following specification in conjunction with the drawings.

### BRIEF DESCRIPTION OF THE DRAWINGS

FIG. 1 is a front perspective view of a vehicle with a vision and sensing system that incorporates a camera and a sensor in accordance with the present invention;

FIG. 2 is a plan view showing lane detection utilizing a camera;

FIG. 3 is a plan view showing the lane detection mechanism using a camera and a non-vision sensor in accordance with the present invention;

FIG. 4 is a side view of showing the lane detection mechanism of FIG. 3; and

FIG. 5 is a block diagram showing the lane detection mechanism of the present invention.

### LEGEND

10—Subject vehicle
12—Front windshield camera
14—Windshield of vehicle
16—Non-vision sensing system
18—Ground penetrating radar or equivalent device
20—Front windshield camera detection range
22—Lane marking
24—Missing lane marking
26—Lane marking objects or elements embedded under the road surface
28—Road, including portion of the road below the road surface
28a—Road surface
30—Ground penetrating radar device detection range
32—Sensor fusion
34—Lane marking objects detection

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

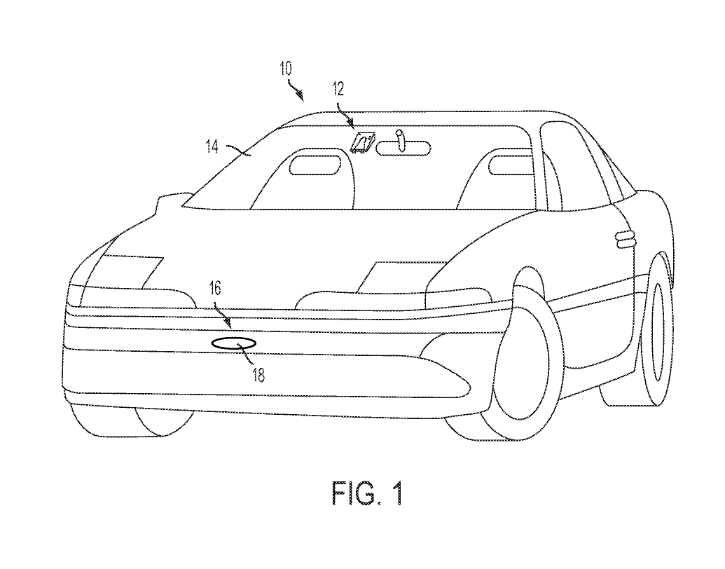

Referring now to the drawings and the illustrative embodiments depicted therein, vision system for a vehicle 10 includes at least one exterior viewing imaging sensor or camera 12, such as a forward viewing imaging sensor or camera, which may be disposed at and behind the windshield 14 of the vehicle and viewing forward through the windshield so as to capture image data representative of the scene occurring forward of the vehicle (FIG. 1). Optionally, the system may include multiple exterior viewing imaging sensors or cameras, such as a forward viewing camera at the front of the vehicle, and a sideward/rearward viewing camera at respective sides of the vehicle, and a rearward viewing camera at the rear of the vehicle, which capture images exterior of the vehicle. The camera or cameras each include a lens for focusing images at or onto an imaging array or imaging plane or imager of the camera. Optionally, the forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system includes a control or electronic control unit (ECU) or processor that is operable to process image data captured by the camera or cameras and may detect objects or the like and/or provide displayed images at a display device for viewing by the driver of the vehicle. The data transfer or signal communication from the camera to the ECU may comprise any suitable data or communication link, such as a vehicle network bus or the like of the equipped vehicle.

The system of the present invention also includes a radar sensing system 16 (or other suitable non-vision sensing system) comprising one or more sensors 18 disposed at a front portion of the vehicle. The sensor 18 senses the presence of a device or element disposed at or at least partially embedded in a road being traveled by the vehicle, as discussed below.

At present, the advanced driving assistance systems utilize the front camera or sound view system to detect the lanes. This method is heavily dependent on the visibility of the visible lane markings painted on the road being traveled by the vehicle. Such lane markers tend to wear out very often, and may be obscured or less visible or discernible if there is a heavy rain during night. In snow conditions, the camera may not be able to detect the lane markings if the lanes are covered by the snow. For level 4 and level 5 automated driving systems, since there will not be any human supervision, it is very important to have highly reliable lane sensing.

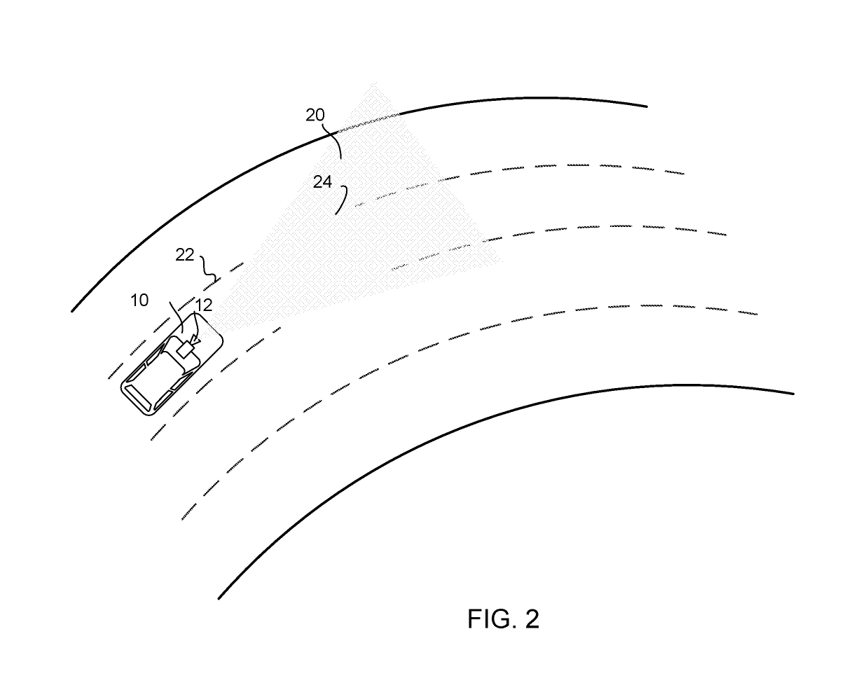

FIG. 2 illustrates a view of the subject vehicle 10 equipped with a front camera module 12 installed on the windshield that has a detection range (see region 20) that can detect the lane markings 22. FIG. 2 also illustrates a patch of the road 24 where the lane marking is missing.

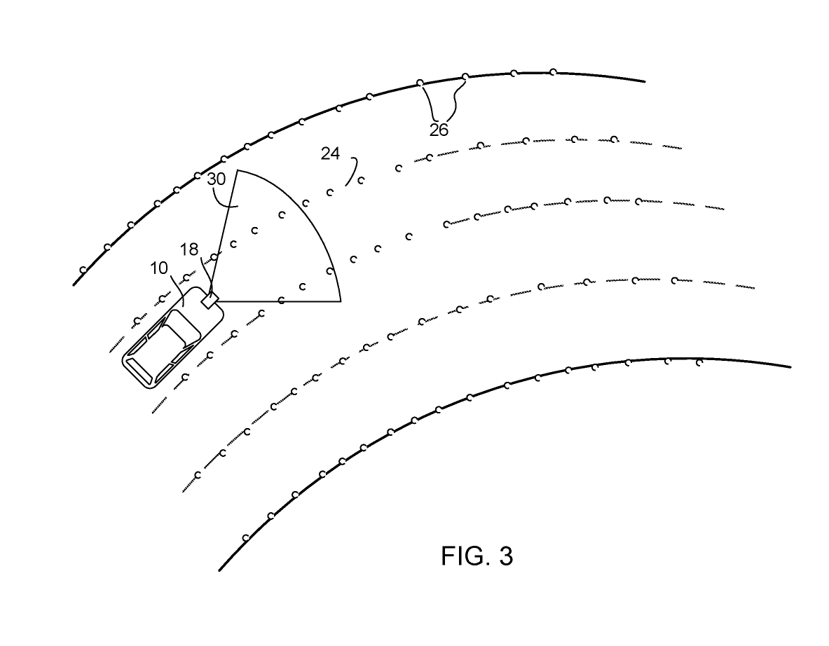

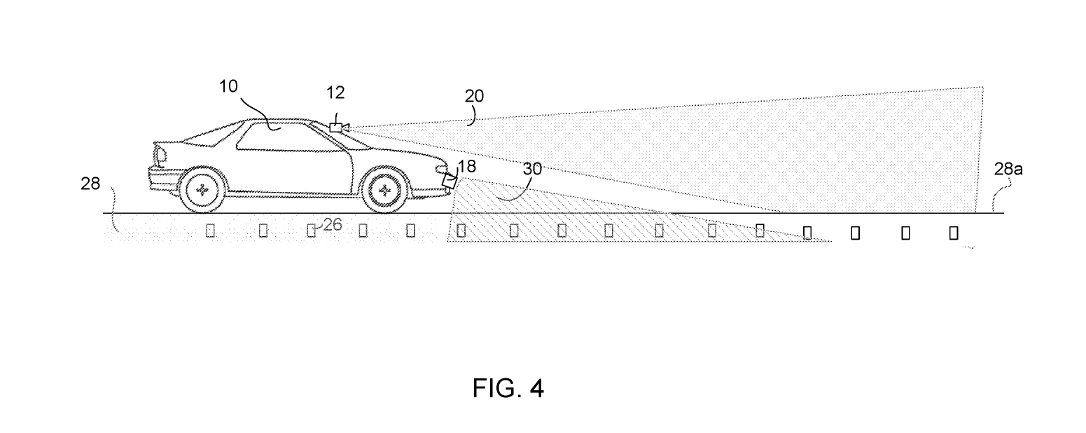

FIG. 3 illustrates the same scenario as FIG. 2, but in this case the subject vehicle 10 is equipped with ground penetrating radar or equivalent sensing device 18, which can detect the road-embedded lane marking elements or objects 26 at least partially embedded below the surface 28a of the road 28 and has a detection range (see region 30). FIG. 4 illustrates the side view of the reliable lane detection mechanism of the present invention, showing both the camera or vision system and the radar or non-vision system. The road-embedded elements 26 may be embedded in the road beneath the surface or may be disposed at the surface or at recesses at the surface (where the road-embedded elements is recessed in the road and generally flush with the road surface). Optionally, the road-embedded elements may be part of a reflector element or the like disposed along the lane markers. The road-embedded elements may comprise any suitable element or object that provide different responses for the radar system, such that the system can detect the road-embedded elements and distinguish them from other objects or elements of or along the road.

The control, responsive to processing at the at least one processor of image data captured by the camera, detects the visible lane markers painted on and along road along which the vehicle is traveling, and the control, responsive to processing at the at least one processor of sensor data captured by the sensor, detects the road-embedded elements at least partially embedded in the road along which the vehicle is traveling. The road-embedded elements comprise a plurality of road-embedded elements at least partially embedded at the road along which the vehicle is traveling, with the plurality of road-embedded elements comprising at least a first set of road-embedded elements and a second set of road-embedded elements. Road-embedded elements of the first set are laterally spaced from corresponding road-embedded elements of the second set by a distance corresponding to a traffic lane along which a vehicle on the road may travel (such as by a distance of about twelve feet). The road-embedded elements of each set correspond with a respective set or side lane marker of the visible lane markers. The control determines at least the lane along which the equipped vehicle is traveling based on the detected lane markers or the detected road-embedded elements.

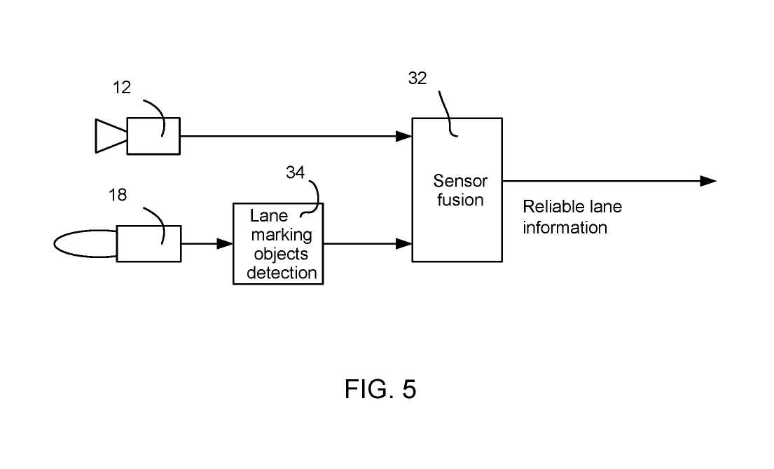

FIG. 5 illustrates a block diagram of the reliable lane detection mechanism or system of the present invention in which the front camera 12 lane marking data is fused in a sensor fusion block 32 with the lane marking object position data 34 utilizing the ground penetrating radar or equivalent device 18. When the lane markings are missing or snow covered or at night time with heavy rain, the system can still output reliable lane location infatuation utilizing the output 34.

To reduce processing requirements, the system of the present invention may utilize the image data captured by the camera as a default way of detecting lane markers and determining the lanes of the road (when the lane markers are exposed and viewable by the camera), and may not utilize the radar sensor in such situations (when the camera is capable of detecting lane markers). When it is determined that the lane markers are worn or obscured or not viewable, the system may utilize the sensor data sensed by the ground penetrating radar sensor to detect the lane objects or elements embedded in or disposed on or in the road.

The system may provide an output indicative of the determined lane or lanes (as determined based on processing of the captured image data or processing of the captured sensor data). The output is provided to a driving assist system of the vehicle, such as a lane departure warning system or such as a lane keep assist system or the like. Optionally, the output may be provided to an autonomous vehicle control system, whereby the vehicle is autonomously controlled to follow the lane in which the vehicle is traveling.

For autonomous vehicles suitable for deployment with the system of the present invention, an occupant of the vehicle may, under particular circumstances, be desired or required to take over operation/control of the vehicle and drive the vehicle so as to avoid potential hazard for as long as the autonomous system relinquishes such control or driving. Such occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system. The forward viewing camera and/or the sensor of the lane determining system may comprise one of the cameras and/or one of the sensors of the autonomous vehicle control system.

The non-vision system utilizes any suitable sensors, such as radar or lidar sensors or the like, for sensing elements or devices or the like disposed at the road and capable of being sensed by the selected sensor type. The sensing system may utilize aspects of the systems described in U.S. Pat. Nos. 9,753,121; 9,689,967; 9,599,702; 9,575,160; 9,146,898; 9,036,026; 8,027,029; 8,013,780; 6,825,455; 7,053,357; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 6,919,549; 6,906,793; 6,876,775; 6,710,770; 6,690,354; 6,678,039; 6,674,895 and/or 6,587,186, and/or International Publication Nos. WO 2018/007995 and/or WO 2011/090484, and/or U.S. Publication Nos. US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in International Publication Nos. WO 2010/144900; WO 2013/043661 and/or WO 2013/081985, and/or U.S. Pat. No. 9,126,525, which are hereby incorporated herein by reference in their entireties.

Optionally, the camera may comprise a forward viewing camera, such as disposed at a windshield electronics module (WEM) or the like. The forward viewing camera may utilize aspects of the systems described in U.S. Pat. Nos. 8,256,821; 7,480,149; 6,824,281 and/or 6,690,268, and/or U.S. Publication Nos. US-2015-0327398; US-2015-0015713; US-2014-0160284; US-2014-0226012 and/or US-2009-0295181, which are all hereby incorporated herein by reference in their entireties.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or a 4G or 5G broadband cellular network) technology provides for communication between vehicles and/or infrastructure based on information provided by one or more vehicles and/or information provided by a remote server or the like. Such vehicle communication systems may utilize aspects of the systems described in U.S. Pat. Nos. 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,708,410; 5,737,226; 5,802,727; 5,878,370; 6,087,953; 6,173,501; 6,222,460; 6,513,252 and/or 6,642,851, and/or U.S. Publication Nos. US-2014-0022390; US-2012-0162427; US-2006-0050018 and/or US-2006-0061008, which are all hereby incorporated herein by reference in their entireties. Optionally, the vision system (utilizing the forward viewing camera and a rearward viewing camera and other cameras disposed at the vehicle with exterior fields of view) may be part of or may provide a display of a top-down view or bird's-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A lane determining system for a vehicle, said lane determining system comprising:
a camera disposed at a vehicle so as to have a field of view forward of the vehicle, wherein said camera captures image data;
a non-vision based sensor disposed at the vehicle so as to have a field of sensing forward of the vehicle, wherein said non-vision based sensor captures sensor data;
a control comprising at least one processor that processes image data captured by said camera and sensor data captured by said non-vision based sensor;
wherein said control, responsive to processing at the at least one processor of image data captured by said camera, detects visible lane markers painted on and along road along which the vehicle is traveling;
a plurality of road-embedded elements at least partially embedded at the road along which the vehicle is traveling, wherein the plurality of road-embedded elements comprises at least a first set of road-embedded elements and a second set of road-embedded elements, and wherein road-embedded elements of the first set are laterally spaced from corresponding road-embedded elements of the second set by a distance corresponding to a traffic lane along which a vehicle on the road may travel, wherein the road-embedded elements of each set correspond with a respective set of visible lane markers;
wherein said control, responsive to processing at the at least one processor of sensor data captured by said non-vision based sensor, detects the first and second sets of road-embedded elements at least partially embedded in the road along which the vehicle is traveling; and
wherein said control determines at least the lane along which the equipped vehicle is traveling based on the detected lane markers or the detected road-embedded elements.

2. The lane determining system of claim 1, wherein the road-embedded elements are embedded in the road beneath a surface of the road.

3. The lane determining system of claim 1, wherein the road-embedded elements protrude above the road surface.

4. The lane determining system of claim 1, wherein individual road-embedded elements of the first set are spaced twelve feet apart from corresponding individual road-em bedded elements of the second set.

5. The lane determining system of claim 1, wherein said non-vision based sensor comprises a radar sensor.

6. The lane determining system of claim 1, wherein said control determines at least the lane along which the equipped vehicle is traveling via processing at the at least one processor of image data captured by said camera when the visible lane markers are exposed and viewable at the road surface.

7. The lane determining system of claim 1, wherein said control determines at least the lane along which the equipped vehicle is traveling via processing at the at least one processor of sensor data captured by said non-vision based sensor when the visible lane markers are missing or covered or not viewable at the road surface.

8. The lane determining system of claim 1, wherein said control does not utilize sensor data captured by said non-vision based sensor to determine at least the lane along which the equipped vehicle is traveling when the visible lane markers are exposed and detected via processing of image data captured by said camera.

9. The lane determining system of claim 1, wherein image data captured by said camera is fused with sensor data captured by said non-vision based sensor to provide reliable lane information.

10. The lane determining system of claim 1, wherein said lane determining system provides an output to a driving assist system of the equipped vehicle, wherein the output is indicative of the determined lane along which the equipped vehicle is traveling.

11. The lane determining system of claim 10, wherein the driving assist system comprises a system selected from the group consisting of (i) a lane keep assist system of the equipped vehicle and (ii) a lane departure warning system of the equipped vehicle.

12. The lane determining system of claim 10, wherein the driving assist system comprises an autonomous vehicle control system of the equipped vehicle.

13. A lane determining system for a vehicle, said lane determining system comprising:
a radar sensor disposed at the vehicle so as to have a field of sensing forward of the vehicle, wherein said radar sensor captures sensor data;
a control comprising a processor that processes sensor data captured by said radar sensor;
a plurality of road-embedded elements at least partially embedded at the road along which the vehicle is traveling, wherein the plurality of road-embedded elements comprises at least a first set of road-embedded elements and a second set of road-embedded elements, and wherein road-embedded elements of the first set are laterally spaced from corresponding road-embedded elements of the second set by a distance corresponding to a traffic lane along which a vehicle on the road may travel, wherein the road-embedded elements of each set correspond with a respective set of visible lane markers painted on the road surface;
wherein said control, responsive to processing at the processor of sensor data captured by said radar sensor, detects the first and second sets of road-embedded elements at least partially embedded in the road along which the vehicle is traveling; and
wherein said control determines at least the lane along which the equipped vehicle is traveling based on the detected road-embedded elements.

14. The lane determining system of claim 13, wherein said control determines at least the lane along which the equipped vehicle is traveling via processing at the processor of data captured by said radar sensor at least when the visible lane markers are missing or covered or not viewable at the road surface.

15. The lane determining system of claim 13, wherein said lane determining system provides an output to a driving assist system of the equipped vehicle, wherein the output is indicative of the determined lane along which the equipped vehicle is traveling.

16. The lane determining system of claim 15, wherein the driving assist system comprises a system selected from the group consisting of (i) a lane keep assist system of the equipped vehicle, (ii) a lane departure warning system of the equipped vehicle and (iii) an autonomous vehicle control system of the equipped vehicle.

17. A lane determining system for a vehicle, said lane determining system comprising:
a camera disposed at a vehicle so as to have a field of view forward of the vehicle, wherein said camera captures image data;
a radar sensor disposed at the vehicle so as to have a field of sensing forward of the vehicle, wherein said radar sensor captures sensor data;
a control comprising at least one processor that processes image data captured by said camera and sensor data captured by said radar sensor;
wherein said control, responsive to processing at the at least one processor of image data captured by said camera, detects visible lane markers painted on and along road along which the vehicle is traveling;
a plurality of road-embedded elements at least partially embedded at the road along which the vehicle is traveling, wherein the plurality of road-embedded elements comprises at least a first set of road-embedded elements and a second set of road-embedded elements, and wherein road-embedded elements of the first set are laterally spaced from corresponding road-embedded elements of the second set by a distance corresponding to a traffic lane along which a vehicle on the road may travel, wherein the road-embedded elements of each set correspond with a respective set of visible lane markers;
wherein said control, responsive to processing at the at least one processor of sensor data captured by said radar sensor, detects the first and second sets of road-embedded elements at least partially embedded in the road along which the vehicle is traveling;
wherein said control determines at least the lane along which the equipped vehicle is traveling via processing at the at least one processor of image data captured by said camera when the visible lane markers are exposed and viewable at the road surface; and
wherein said control determines at least the lane along which the equipped vehicle is traveling via processing at the at least one processor of sensor data captured by said radar sensor when the visible lane markers are missing or covered or not viewable at the road surface.

18. The lane determining system of claim 17, wherein said control does not utilize sensor data captured by said radar sensor to determine at least the lane along which the equipped vehicle is traveling when the visible lane markers are exposed and detected via processing of image data captured by said camera.

19. The lane determining system of claim 17, wherein image data captured by said camera is fused with sensor data captured by said radar sensor to provide reliable lane information.

20. The lane determining system of claim 17, wherein said lane determining system provides an output to a driving assist system of the equipped vehicle, wherein the output is indicative of the determined lane along which the equipped vehicle is traveling, and wherein the driving assist system comprises a system selected from the group consisting of (i) a lane keep assist system of the equipped vehicle, (ii) a lane departure warning system of the equipped vehicle and (iii) an autonomous vehicle control system of the equipped vehicle.
